(19) United States
(12) Patent Application Publication
(10) Pub. No.: US 2007/0227293 A1
(43) Pub. Date: Oct. 4, 2007

(54) Bicycle crank arm assembly and related elements

(75) Inventor: Maurizio Valle, Vicenza (IT)

Correspondence Address: VOLPE AND KOENIG, P.C., UNITED PLAZA, SUITE 1600, 30 SOUTH 17TH STREET, PHILADELPHIA, PA, 19103, US

(73) Assignee: Campagnolo S.r.l., Vicenza (IT)

(21) Appl. No.: 11/717,333

(22) Filed: Mar. 13, 2007

(30) Foreign Application Priority Data
Mar. 29, 2006 (EP) 06425218.2

(51) Int. Cl. G05G 1/14

(52) U.S. Cl. 74/594.1

(57) ABSTRACT

A bicycle crank arm assembly is disclosed, comprising a crank arm having a first end for coupling with a bottom bracket assembly and a second end for coupling with a pedal, at least one of the first end and the second end comprising a hole extending from a side of the crank arm for coupling with an axle of the pedal or of the bottom bracket assembly, respectively, further comprising a reinforcing element extending around the hole in the proximity of the side of the crank arm, having a portion configured for receiving an abutment portion of the axle resting upon it, and wherein the crank arm and the reinforcing element contact along a respective surface not entirely contained within a plane perpendicular to an axis of the hole.

### FIELD OF INVENTION

The present invention refers to a bicycle crank arm assembly, a crank arm, and a reinforcing element for a bicycle crank arm.

### BACKGROUND

Bicycle crank arms have a hole for receiving an axle of the pedal or respectively of the bottom bracket assembly. The hole is typically threaded or in any case includes a non-smooth wall to prevent the mutual rotation between the crank arm and the axle, for example it has a polygonal cross-section, in particular square or hexagonal, or else it is a cylindrical or conical hole having grooves or protrusions.

The problem with the known crank arms is that they easily brake in the hole areas, therefore an improved crank arm is needed.

### SUMMARY

The invention concerns, in a first aspect thereof, a bicycle crank arm assembly comprising a crank arm having a first end for coupling with a bottom bracket assembly and a second end for coupling with a pedal, at least one of the first end and the second end comprising a hole extending from one side—distal or proximal, respectively—of the crank arm for coupling with an axle of the pedal or of the bottom bracket assembly, respectively, further comprising a reinforcing element or washer extending around the hole in the proximity of or at the side of the crank arm, having a portion configured for receiving an abutment portion of the axle resting upon it, and wherein the crank arm and the reinforcing element contact along a respective surface not entirely contained within a plane perpendicular to an axis of the hole.

In a second aspect thereof, the invention concerns a bicycle crank arm having a first end for coupling with an axle of the bottom bracket assembly and a second end for coupling with a pedal, at least one of the first end and the second end comprising a hole extending from one side—distal or proximal, respectively—of the crank arm for coupling with an axle of the pedal or of the bottom bracket assembly, respectively, further comprising, in the proximity of or at the side, a surface configured for contacting a reinforcing element not entirely contained in a plane perpendicular to an axis of the hole.

In a third aspect thereof, the invention concerns a reinforcing element for a bicycle crank arm, characterized by comprising a hole configured for allowing passage of an axle of the pedal or of the bottom bracket assembly, respectively, a portion configured for receiving an abutment portion of the axle resting upon it, and a surface configured for contacting the crank arm not entirely contained within a plane perpendicular to an axis of the hole.

### BRIEF DESCRIPTION OF THE DRAWING(S)

Further characteristics and advantages of the present invention shall become clearer from the following detailed description of some preferred embodiments thereof, made with reference to the attached drawings, purely as a non-limiting example. In the drawings:

FIG. 1 is a partially sectional side view of a crank arm assembly according to the present invention coupled with the axle of a pedal;

FIG. 2 is an enlarged cross-section of a part of the coupling area between the crank arm assembly and the axle of FIG. 1;

FIG. 3 is an enlarged cross-section of a part of the pedal coupling area of the crank arm assembly of FIG. 1, wherein the forces acting on a reinforcing element thereof are schematically shown;

FIG. 4A is a plan view of the crank arm of the crank arm assembly of FIG. 1, wherein the forces acting on the reinforcing element are schematically shown;

FIG. 4B is a partial exploded view of the crank arm and washer of the crank arm assembly of FIG. 1;

FIGS. 5 to 11 are sections of the pedal coupling area of crank arm assemblies according to other embodiments of the present invention;

FIG. 12 is a cross-section of the pedal coupling area of a crank arm assembly according to another embodiment of the present invention;

FIG. 13 is an enlarged cross-section of the coupling area between the washer and the crank arm of the crank arm assembly of FIG. 12;

FIG. 14 is a cross-section of the pedal coupling area of a crank arm assembly according to another embodiment of the present invention;

FIG. 15 is a cross-section of the pedal coupling area of a crank arm assembly according to another embodiment of the present invention, wherein the mutual contact surfaces of the crank arm and the washer have a different extent at different angular positions;

FIG. 16 is a plan view of the crank arm of the crank arm assembly of FIG. 15;

FIG. 17 is a section of the pedal coupling area of crank arm assembly according to another embodiment of the present invention, wherein the mutual contact surfaces of the crank arm and the washer have a different extent at different angular positions; and

FIG. 18 is a partial perspective view of a crank arm assembly according to another embodiment of the present invention.

### DETAILED DESCRIPTION OF THE PREFERRED EMBODIMENT(S)

Introduction

The invention concerns, in a first aspect thereof, a bicycle crank arm assembly comprising a crank arm having a first end for coupling with a bottom bracket assembly and a second end for coupling with a pedal, at least one of the first end and the second end comprising a hole extending from one side—distal or proximal, respectively—of the crank arm for coupling with an axle of the pedal or of the bottom bracket assembly, respectively, further comprising a reinforcing element or washer extending around the hole in the proximity of or at the side of the crank arm, having a portion configured for receiving an abutment portion of the axle resting upon it, and wherein the crank arm and the reinforcing element contact along a respective surface not entirely contained within a plane perpendicular to an axis of the hole.

Applicant has perceived that the main cause of fatigue breaking of the crank arms is tensile stress that occurs in the area around the hole when the cyclist pushes on the pedals.

Applicant has also noted that the maximum tensile stress occurs in the surface area of the hole, on the side from which the axle of the pedal or of the bottom bracket assembly protrudes.

In the crank arm assembly according to the invention, due to the friction forces arising at the mutual contact surfaces of the crank arm and the reinforcing element, the latter is able to absorb a part of the stresses in the surface area of the hole, straining with the crank arm and taking the load off the crank arm. In this manner, the residual tensile stress in the crank arm is no longer enough to start and propagate the fractures at the direction changes of the surface of the hole.

Preferably, the mutual contact surfaces have an overall sloping progression with respect to the axis so that the friction forces are more distributed in the body of the reinforcing element.

In the present description and in the attached claims, “overall sloping progression” indicates contact surfaces that can locally depart from a ćonical surface.

Typically, the surface of the hole, at least in the portion in the proximity of the reinforcing element, is a surface with a non-smooth wall. The axle is thus effectively held at least in the area of maximum stress.

In the direction of the axis of the hole, preferably the mutual contact surfaces have a shorter extent than that of the hole, more preferably less than half the extent of the hole, and even more preferably less than a fifth of the extent of the hole. In this manner, the overall weight of the crank arm is reduced.

In a particularly preferred way, in the direction of the axis the extent of the mutual contact surfaces is comprised between one pitch of an inner threading of the hole and twice the pitch.

According to a particularly preferred characteristic of the crank arm assembly of the present invention, the reinforcing element has a greater modulus of elasticity than that of the crank arm, so that it is able to absorb a substantial portion of tensile stress of the crank arm.

Preferably, but not limited thereto, the material used to make the reinforcing element with the desired modulus of elasticity is selected from among steel, titanium alloy, and aluminum alloy.

In first embodiments, the mutual contact surfaces are conical surfaces. In this case, the friction forces act upon many planes perpendicular to the axis and continually arranged one adjacent to the other, substantially for the entire extent of the conical contact region. The friction action is therefore exerted uniformly throughout the body of the reinforcing element.

Preferably, the generating line of the mutual contact surfaces is sloped with respect to a plane perpendicular to the axis by an angle comprised between 5° and 45°, and most preferably between 25° and 35°.

In order to increase the area of the mutual contact surfaces of the crank arm and the washer, and therefore the friction forces, the mutual contact surfaces can be rotational surfaces having a curvilinear generating line with two or more inflexion points, rotational surfaces having a curvilinear generating line with one inflexion point, rotational surfaces having a generating line shaped as an arc of circumference, rotational surfaces having a stepped generating line, or other surfaces, for example, deriving from a combination of the above.

The mutual contact surfaces of the crank arm and the washer can also not be rotational surfaces, for example, multi-faceted surfaces and preferably frustum of pyramid-shaped surfaces.

In the above embodiments as well as in others, the contact surface of the reinforcing element can overall converge towards the crank arm, and the contact surface of the crank arm can overall diverge towards the reinforcing element or, vice-versa, the contact surface of the reinforcing element can overall diverge towards the crank arm, and the contact surface of the crank arm can overall converge towards the reinforcing element.

The crank arm can comprise a recessed seat for housing the reinforcing element. The crank arm can alternatively comprise a protruding seat for housing the reinforcing element.

Preferably a mechanical constraint is further provided between the crank arm and the reinforcing element so that the mutual sliding thereof is minimized if not eliminated. The reinforcing element or washer is thus strained even more as a single piece with the crank arm, and its efficiency increases.

The mechanical constraint can comprise a caulking, in particular a caulking of the crank arm and/or of the reinforcing element around the recessed or protruding seat.

When the crank arm is made from a composite material, the mechanical constraint can be accomplished by co-molding of the reinforcing element in the crank arm.

The mutual contact surfaces between the crank arm and the reinforcing element can have a different extent at different angular positions about the axis.

Since the force that the cyclist exerts on the pedal changes in strength during the pedaling cycle and thus as a function of the angular position of the crank arm assembly, with the above provision it is possible to modify the mutual contact surfaces so as to increase the friction during the portion of the pedaling cycle when the greatest force is exerted compared to the portion of the pedaling cycle when the smallest force is exerted.

In another embodiment, the mutual contact surfaces of the crank arm and the reinforcing element are eccentric surfaces with respect to the hole. Preferably, in this case the axis of the mutual contact surfaces is parallel to the axis of the hole and defines therewith a plane sloping with respect to a longitudinal center line of the crank arm by an angle comprised between 30° and 70°.

In yet another embodiment, the mutual contact surfaces of the crank arm and the reinforcing element have a different slope at different angular positions about the axis.

In a second aspect thereof, the invention concerns a bicycle crank arm having a first end for coupling with an axle of the bottom bracket assembly and a second end for coupling with a pedal, at least one of the first end and the second end comprising a hole extending from one side—distal or proximal, respectively—of the crank arm for coupling with an axle of the pedal or of the bottom bracket assembly, respectively, characterized by comprising, in the proximity of or at the side, a surface configured for contacting a reinforcing element not entirely contained in a plane perpendicular to an axis of the hole.

The crank arm preferably has one or more of the features described above in connection with the crank arm assembly.

In a third aspect thereof, the invention concerns a reinforcing element for a bicycle crank arm, characterized by comprising a hole configured for allowing passage of an axle of the pedal or of the bottom bracket assembly, respectively, a portion configured for receiving an abutment portion of the axle resting upon it, and a surface configured for contacting the crank arm not entirely contained within a plane perpendicular to an axis of the hole.

The reinforcing element preferably has one or more of the features described above in connection with the crank arm assembly.

### DETAILED DESCRIPTION

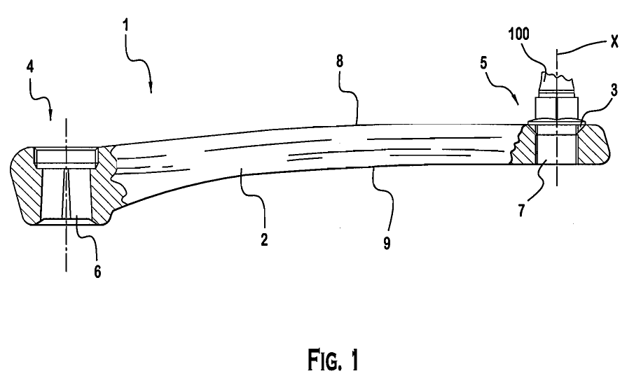

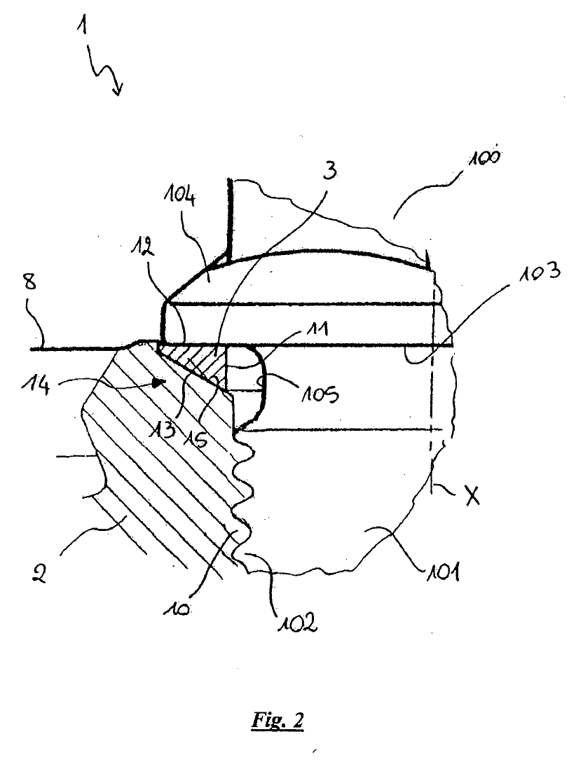

With reference to FIGS. 1 to 4B, a crank arm assembly 1 according to a first embodiment of the invention comprises a crank arm 2 and at least one reinforcing element or washer 3.

The crank arm 2 can be made from metallic material, typically light alloys like aluminum alloys, or from composite material. The composite material used preferably comprises structural fibers embedded in a polymeric material. Typically, the structural fibers are selected from the group consisting of carbon fibers, glass fibers, aramid fibers, ceramic fibers, boron fibers, and combinations thereof, carbon fibers being preferred. Preferably, the polymeric material of the crank arm is thermosetting, but it could be a thermoplastic material. More preferably, the polymeric material comprises an epoxy resin.

The washer 3 is made from a material with a greater modulus of elasticity than the modulus of elasticity of the material of the crank arm 2. For example, the modulus of elasticity of the material of the washer 3 may be about 60.000 N/mm² to 210.000 N/mm², and the modulus of elasticity of the material of the crank arm 2 may be about 5.000 N/mm² to 80.000 N/mm². Preferably, the washer 3 is metallic and, even more preferably, it is made from a material selected from among steel, titanium alloys, and aluminum alloys. Of course, in an extreme case it is possible to have both the crank arm and the washer made of aluminum alloy. However, in this case the former will be made, for example, with an aluminum alloy having a modulus of elasticity of 69.000 N/mm² and the latter will be made, for example, with an aluminum alloy having a modulus of elasticity of 74.000 N/mm².

The crank arm 2 has a first end 4 for coupling with the axle of a bicycle bottom bracket assembly (not shown) and a second end 5 for coupling with an axle 100 of a pedal (not shown).

The first end 4 of the crank arm 2 comprises a hole 6 in which, during use of the crank arm, the axle of the bicycle bottom bracket assembly (not shown) is inserted.

The second end 5 of the crank arm 2 comprises a hole 7, having an axis X, in which, during use of the crank arm, the axle 100 is inserted. The hole 7 extends in the body of the crank arm 2 from the distal side 8 of the crank arm 2, with reference to the center of the bicycle. In the illustrated embodiment, the hole 7 extends up to the proximal side 9 of the body of the crank arm 2, with reference to the center of the bicycle. In other words, in the illustrated embodiment, the hole 7 is a through hole made in the crank arm 2, but, in alternative embodiments, it could be a blind hole.

The hole 7 of the illustrated embodiment is a cylindrical hole having an internal threading 10 having a pitch P, but it could alternatively be a hole with a polygonal, in particular square or hexagonal, cross-section, a cylindrical or conical hole having grooves or protrusions, or a hole configured in another way to prevent the mutual rotation of the axle 100 and of the crank arm 2 about axis X, at least in a portion in the proximity of the distal side 8 of the crank arm 2 and therefore in the proximity of the washer 3.

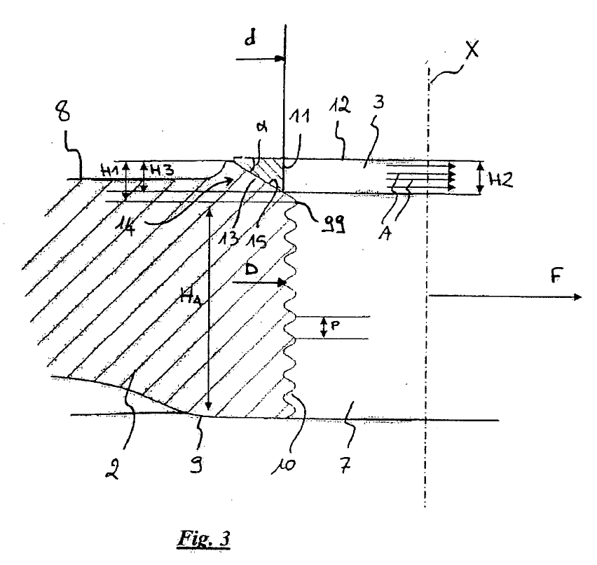

The washer 3 extends around the hole 7 at the distal side 8 of the crank arm 2. More specifically, the washer 3 extends close to the edge 99 of the hole 7. The washer 3 has a hole 11 of a shape and size matching the cross-section of the hole 7 of the crank arm 2, or such as to include it, to allow the insertion of the axle 100. The hole 11 has an axis coinciding with axis X. In FIG. 3, for example, a washer 3 with an inner diameter d greater than the major diameter D of the threading 10 is shown.

The washer 3 has a first substantially flat surface 12 and a second surface 13 substantially opposite surface 12. The second surface 13 of the washer 3 is a conical surface for contacting the crank arm 2, having its axis coinciding with the axis X.

The crank arm 2 has a seat 14 of a shape matching the shape of the washer 3 for receiving the washer 3 and, in particular, having a conical surface 15 for contacting the washer 3, with its axis coinciding with the axis X.

In the direction of axis X, the seat 14 of the crank arm 2 has an extent (i.e., depth) H1 and the washer 3 has an extent (i.e., thickness) H2, the contact zone between the crank arm 2 and the washer 3 has an extent (i.e., height) H3 and the hole 7 has an extent (i.e., depth) H4. It should be noted that, although in FIG. 3 the washer 3 slightly protrudes outside of the seat 14, it could alternatively be flush with the outer edge of the seat 14 and, thus, H3 would be substantially equal to H2. Alternatively, the washer 3 could be housed beneath the outer edge of the seat 14.

The extents H1, H2, and H3 are preferably less than the extent H4 of the hole 7, more preferably less than half the extent H4 of the hole 7, even more preferably less than one fifth of the extent H4. Moreover, in the most preferred embodiment, the extents H1, H2, and H3 are comprised between one and two pitches P of the threading 10 of the hole 7.

Preferably, moreover, the conical surface 15 of the seat 14 of the crank arm 2 and the conical surface 13 of the washer 3, respectively, are sloping with respect to a plane perpendicular to the axis X of the hole 7 of the crank arm 2 and of the hole 11 of the washer 3, respectively, by an angle α comprised between 5° and 45° and even more preferably comprised between 25° and 35°.

As stated, in use a pedal is coupled with the crank arm assembly 1 through the axle 100. The axle 100 has an end portion 101 configured for passing in the hole 11 of the washer 3 and for coupling in the hole 7 of the crank arm 2.

In the illustrated embodiment, the end portion 101 of the axle 100 has a threading 102 matching the internal threading 10 of the hole 7 of the crank arm 2. In other embodiments, the end portion 101 of the axle 100 could have a polygonal cross-section or could be equipped with ridges or grooves matching the cross-section of the hole 7 of the crank arm 2. The axle 100 also has an abutment surface 103, typically made in a flange 104 thereof.

It should be noted that in the illustrated embodiment, the axle 100 also has a peripheral throat 105 arranged between the abutment surface 103 and the end portion 101, so that the inner wall of the hole 11 of the washer 3 does not contact the axle 100. Alternative embodiments do not include the throat 105, thereby allowing the inner wall of the hole 11 of the washer 3 to contact the axle 100.

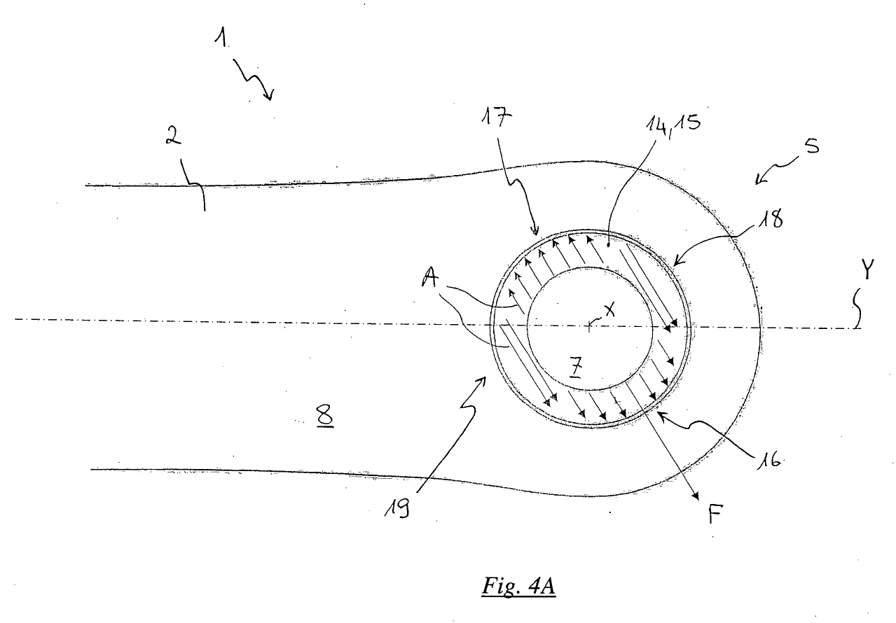

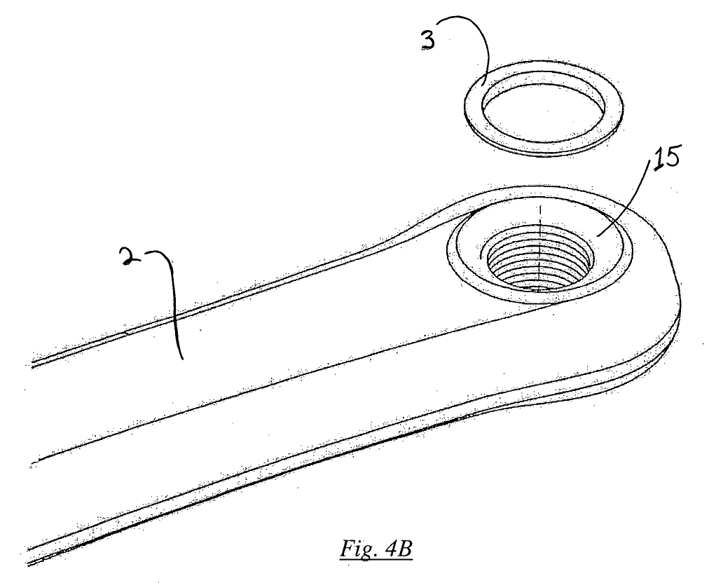

When the end portion 101 of the axle 100 is screwed into the hole 7 of the crank arm 2, the abutment surface 103 abuts the substantially flat surface 12 of the washer 3. The thrust of axle 100 onto the washer 3 creates friction forces A (FIGS. 3 and 4A) that oppose the mutual sliding of the contact surfaces 13 and 15.

In use of the bicycle, when the cyclist pushes on the pedals, the axle 100 further transmits a tensile force to the crank arm 2, at the hole 7. In the most critical condition, wherein the cyclist exerts the maximum thrust on the pedal, the longitudinal axis Y of the crank arm is sloping by about 45° with respect to the horizontal, with the second end 5 above the horizontal passing through the axle of the bottom bracket assembly, and the force exerted by the cyclist is transferred onto the crank arm 2 substantially in the direction of the arrow F illustrated in FIGS. 3 and 4A, sloping by about 45° with respect to the longitudinal center line Y of the crank arm 2. In the present description, for the sake of simplicity, the force component in the plane perpendicular to the middle plane of the crank arm 2 (plane perpendicular to the plane of FIG. 4A) and the moment of the force F or torque are neglected.

With reference to FIG. 4A, the region 16 of the second end 5 of the crank arm 2 adjacent to the force F is therefore subject to a tensile force, whereas the opposite region 17 with respect to the axis X of the hole 7 is not subject to any tensile force. The crank arm 2 is therefore subject to a tensile load, which tends to induce an elastic elongation at the regions 18 and 19 extending between the regions 16 and 17. In other words, the hole 7 of the crank arm 2 has, in use thereof, the tendency to “become oval.”

Due to the repeated load cycles during pedaling, there is the risk of cracks in the throats of the threading 10 of the hole 7—or of the other sharp direction changes of the wall of the hole 7—, especially in the proximity of the distal side 8 of the crank arm 2, and of consequent breaking by fatigue of the crank arm 2.

The conical shape of the mutual contact surfaces 13, 15 of the crank arm 2 and the washer 3 allow the washer 3 to strain or “become oval” together with the crank arm 2, and to absorb part of the tensile force, reducing the aforementioned risks. This is because the friction forces acting in the various directions of the arrows A between the mutual contact surfaces 13 and 15 prevent the mutual sliding between the crank arm 2 and the washer 3. More specifically, in the regions 16, 18, and 19 the friction forces A draw the corresponding region of the washer 3 into elongation as a single piece with the crank arm 2, whereas in the region 17 the friction forces A hold the corresponding region of the washer 3, opposing its sliding on the crank arm 2.

In particular, due to the modulus of elasticity of the constituent material of the washer 3 that is greater than the modulus of elasticity of the constituent material of the crank arm 2, the washer 3 absorbs a substantial part of the tensile stress in the surface region of the hole 7. For example, the modulus of elasticity of the constituent material of the washer 3 may be about 60.000 N/mm² to 210.000 N/mm², and the modulus of elasticity of the constituent material of the crank arm 2 may be about 5.000 N/mm² to 80.000 N/mm². Moreover, as highlighted in FIG. 3, the friction forces A act upon numerous planes perpendicular to the axis X, substantially for the entire extent H3 of the contact region between the crank arm 2 and the washer 3. The holding and the drawing into tension actions of the washer 3 are therefore distributed substantially along its entire extent H2 and therefore in its entire body, increasing the portion of tensile stress absorbed by the washer 3 itself.

Similarly, the change in the cross-section of the seat 14 spreads the stresses in the crank arm 2 over a greater region of material compared with the case of flat contact surface perpendicular to axis X. The absolute value of the local stresses is therefore low.

Since the maximum values of the local stresses in the crank arm 2 are smaller, both because of their better distribution and because they are absorbed by the washer 3, the risk of cracks starting on the distal side 8 at the hole 7 is reduced and therefore the fatigue lifetime of the crank arm 2 is increased.

FIG. 4B illustrates that the washer 3 is preferably continuous. More specifically, the washer 3 is continuous in form without splits or notches which would render it elastic and diminish its reinforcement action.

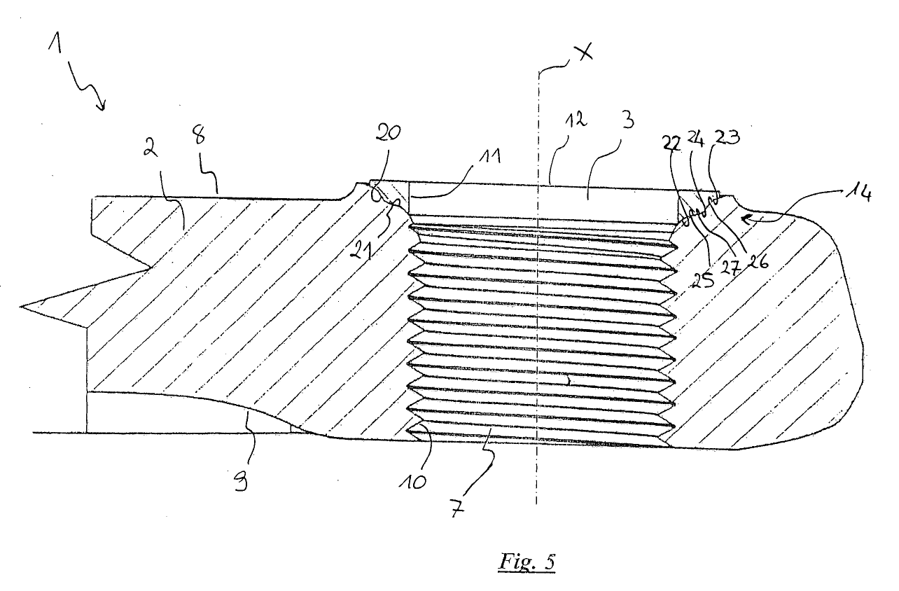

FIGS. 5 to 9 represent alternative embodiments of the crank arm assembly 1, wherein the mutual contact surfaces of the crank arm 2 and the washer 3 are of increased area compared with the case of the embodiment described above, and therefore the friction forces A are advantageously further increased.

In particular, FIG. 5 shows a crank arm assembly 1 wherein the mutual contact surfaces 20, 21 of the washer 3 and of the crank arm 2, respectively, are rotational surfaces having a curvilinear generating line with two inflexion points. More specifically, the generating line of the contact surface 20 of the washer 3 has two concave portions 22, 23 and a convex portion 24 between them, and the generating line of the contact surface 21 of the crank arm 2 has two convex portions 25, 26 and a concave portion 27 between them. Mutual contact surfaces that are rotational surfaces with a generating line having more than two inflexion points can also be used.

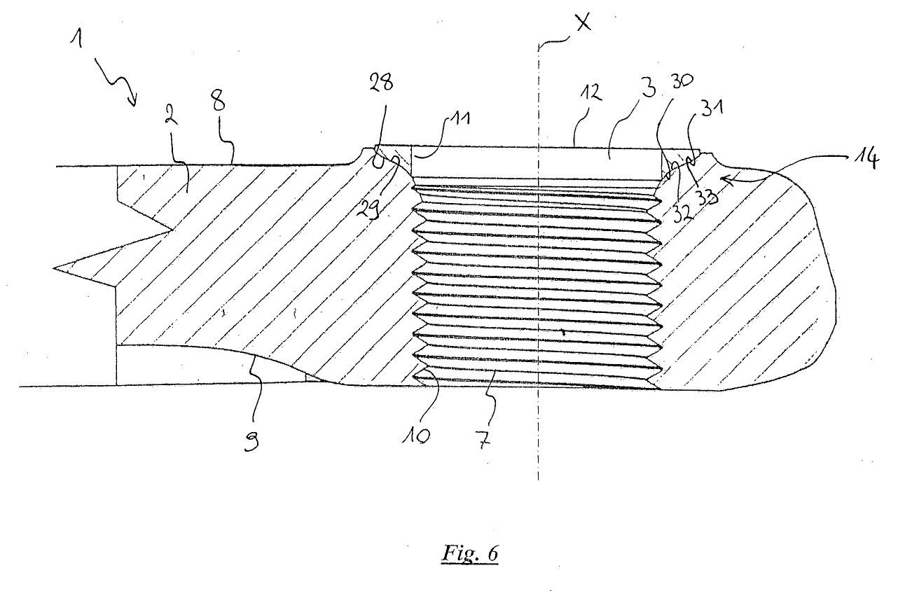

FIG. 6 shows a crank arm assembly 1 wherein the mutual contact surfaces 28, 29 of the washer 3 and of the crank arm 2, respectively, are rotational surfaces having a curvilinear generating line with one inflexion point. More specifically, the generating line of the contact surface 28 of the washer 3 has a concave portion 30 and a convex portion 31, and the generating line of the contact surface 29 of the crank arm 2 has a convex portion 32 and a concave portion 33.

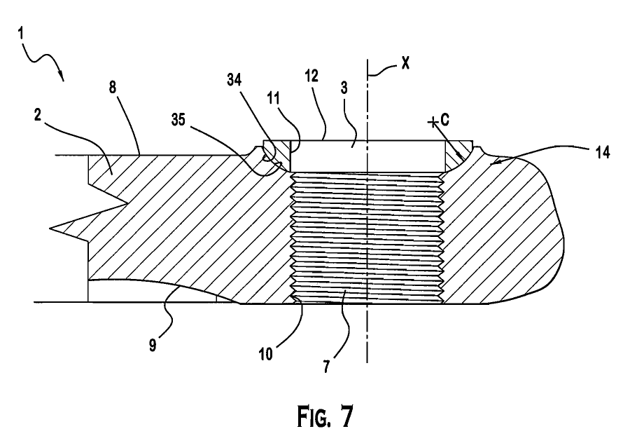

FIG. 7 shows a crank arm assembly 1 wherein the mutual contact surfaces 34, 35 of the washer 3 and of the crank arm 2, respectively, are rotational surfaces having a generating line shaped as an arc of circumference. More specifically, the generating line of the mutual contact surface 34 of the washer 3 is convex, and the generating line of the contact surface 35 of the crank arm 2 is concave. The center C of the arc of circumference does not lie on the axis X, but this possibility is also not ruled out, in which case the surfaces 34, 35 would be spherical.

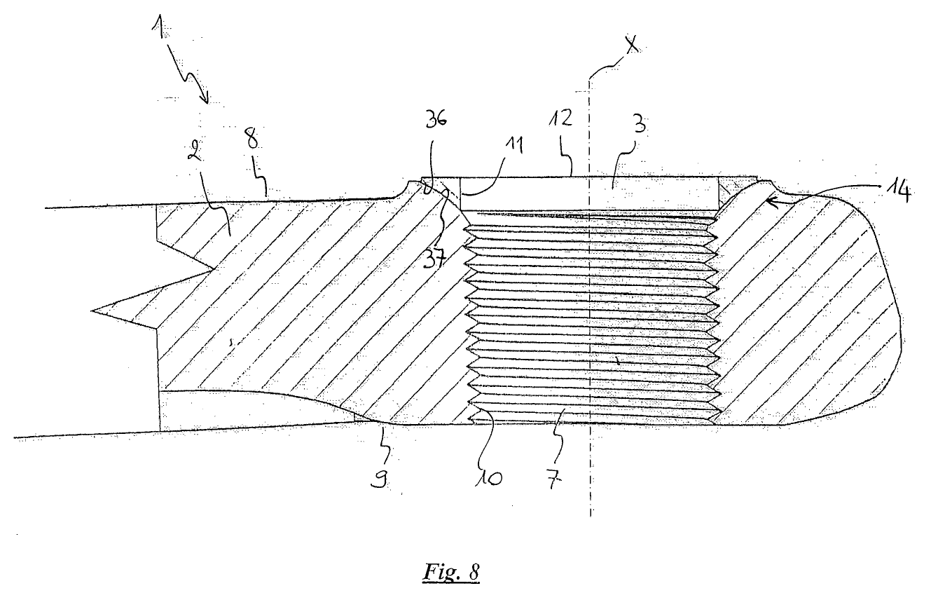

FIG. 8 also shows a crank arm assembly 1 wherein the mutual contact surfaces 36, 37 of the washer 3 and of the crank arm 2, respectively, are rotational surfaces having a generating line shaped as an arc of circumference. In this case, the generating line of the contact surface 36 of the washer 3 is concave and the generating line of the contact surface 37 of the crank arm 2 is convex.

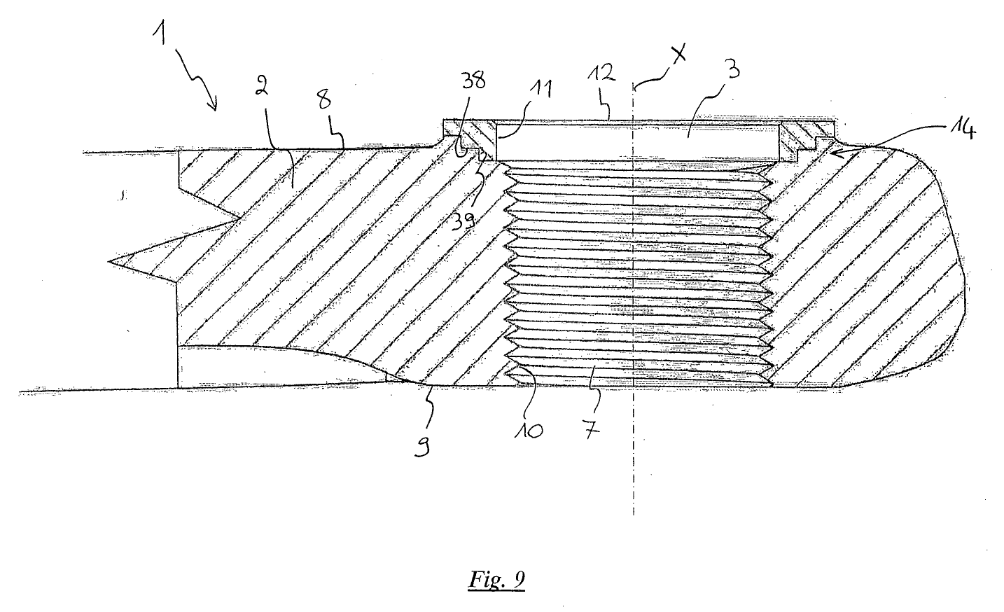

FIG. 9 shows a crank arm assembly 1 wherein the mutual contact surfaces 38, 39 of the washer 3 and of the crank arm 2, respectively, are rotational surfaces having a stepped generating line. Although three steps are illustrated, rotational surfaces having a generating line with two, four, or more steps can be used.

In the above described embodiments, the mutual contact surfaces of the crank arm 2 and the washer 3 have an overall sloping progression with respect to the axis X of the hole 7. More specifically, the contact surface of the washer 3 overall converges towards the crank arm 2, and the contact surface of the crank arm 2 overall diverges towards the washer 3.

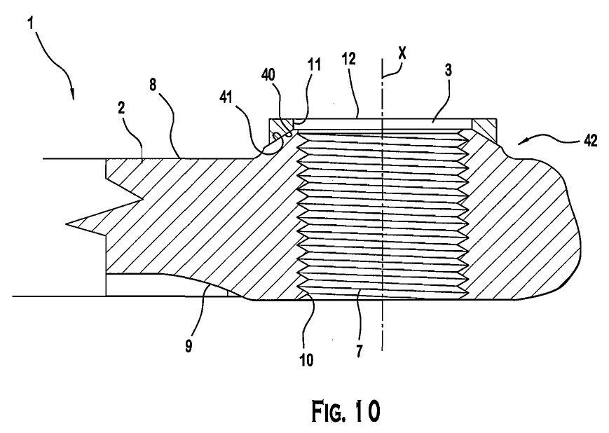

FIG. 10 shows a crank arm assembly 1 wherein the mutual contact surfaces 40, 41 of the washer 3 and of the crank arm 2, respectively, have an overall sloping progression with respect to the axis X of the hole 7, but with opposite orientation with respect to the above described embodiments. In particular, the contact surface 40 of the washer 3 overall diverges towards the crank arm 2, and the contact surface 41 of the crank arm 2 overall converges towards the washer 3. The mutual contact surfaces 40, 41 are more specifically conical, but they could alternatively be surfaces similar to those described above with reference to FIGS. 5 to 9.

The contact surface 41 of the crank arm 2 is also made in a seat 42 protruding from the distal side 8 of the crank arm 2. It should further be understood that in the other described embodiments, the seat 14 recessed into the crank arm 2 for receiving the washer 3 can be replaced by a protruding seat 42.

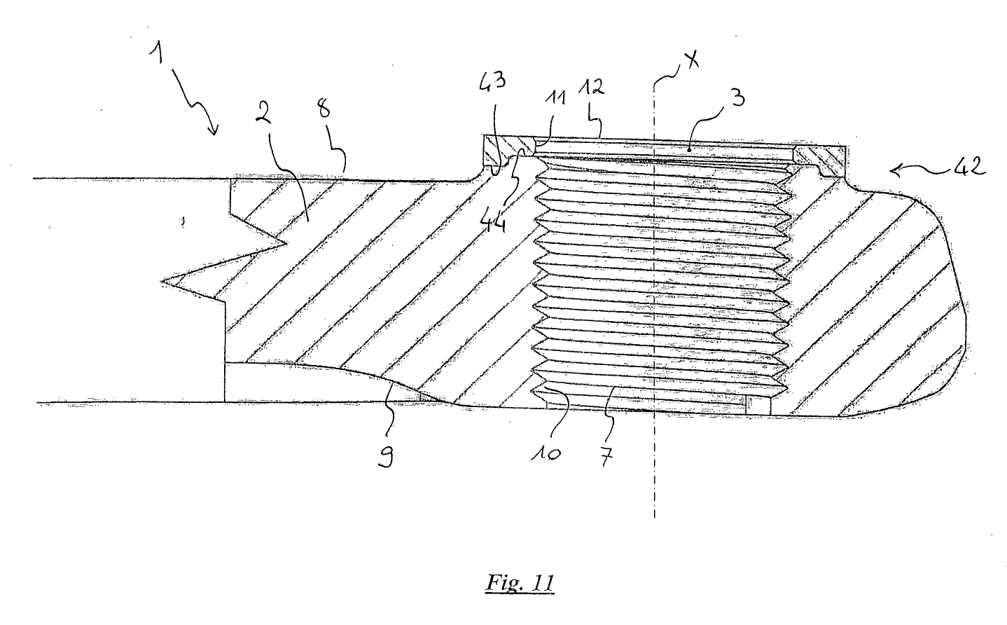

FIG. 11 shows a crank arm assembly 1 wherein the mutual contact surfaces 43, 44 of the washer 3 and of the crank arm 2, respectively, are stepped, with an overall sloping progression with respect to the axis X of the hole 7, with the contact surface 43 of the washer 3 overall diverging towards the crank arm 2, and the contact surface 44 of the crank arm 2 overall converging towards the washer 3.

Further to the effect of friction on the washer 3, it is possible to make the washer 3 strain even more as a single piece with the crank arm 2 and, thus, further protect the crank arm 2 against cracks occurring at the hole 7 in the proximity of the distal side 8, through a mechanical constraint between the crank arm 2 and the washer 3.

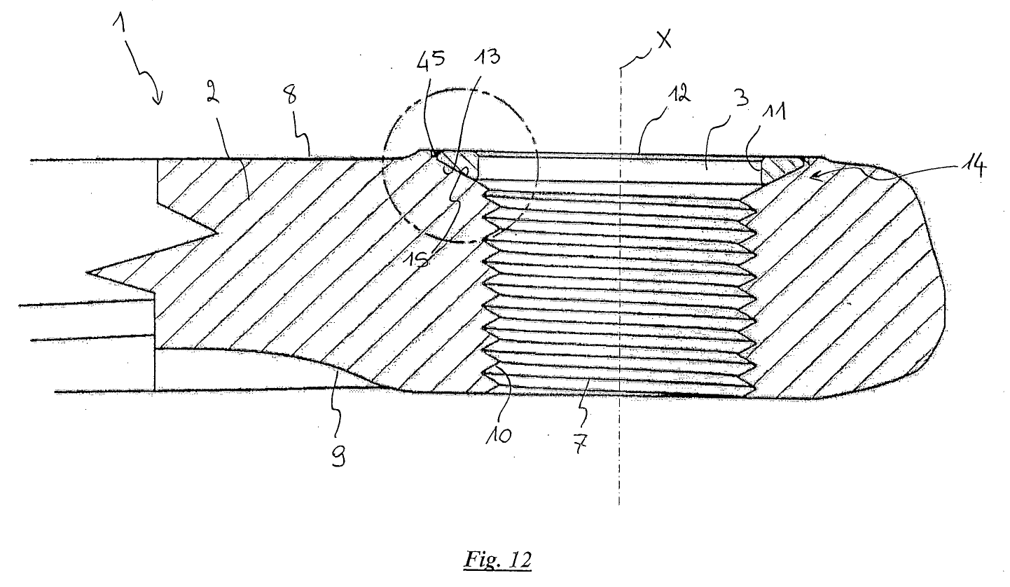

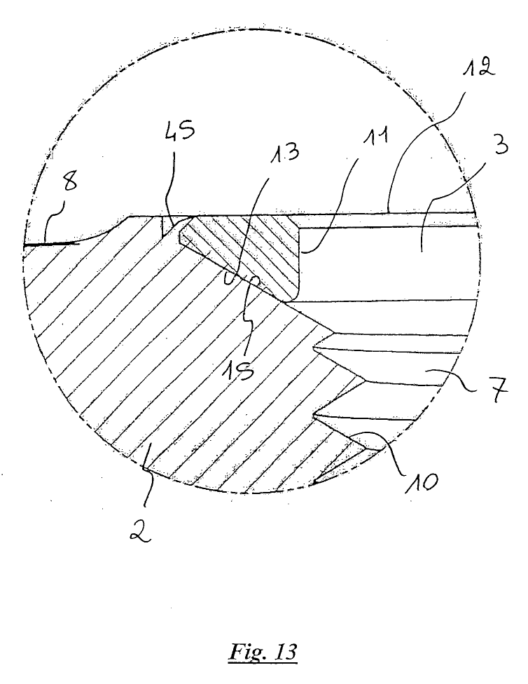

Such a mechanical constraint can be accomplished by caulking the crank arm 2 and/or the washer 3 around the seat 14 or 42 for the washer 3, so that a part of the material of the crank arm 2 partially covers the washer 3 or vice-versa. This is shown by way of example in the embodiment of the crank arm assembly 1 shown in FIG. 12 and in the enlarged view of FIG. 13, wherein a part 45 of the material of the crank arm 2 partially covers the washer 3. The remaining features of the embodiment shown in FIGS. 12 and 13 correspond to the embodiment of FIGS. 1 and 4B, but it should be understood that the mutual contact surfaces of the crank arm 2 and the washer 3 could be made according to the other above-described embodiments.

When the crank arm is made from composite material, it is particularly simple to constrain the washer 3 to the crank arm 2 through co-molding. When the composite material of the crank arm 2 is cured, it adheres to the washer 3 and prevents any relative mutual movement. In this case, the washer 3 can be held by means of the material of the crank arm 2 that partially covers the washer 3, similarly to the caulking material 45, or else through other projections or protrusions made in the side wall of the washer 3.

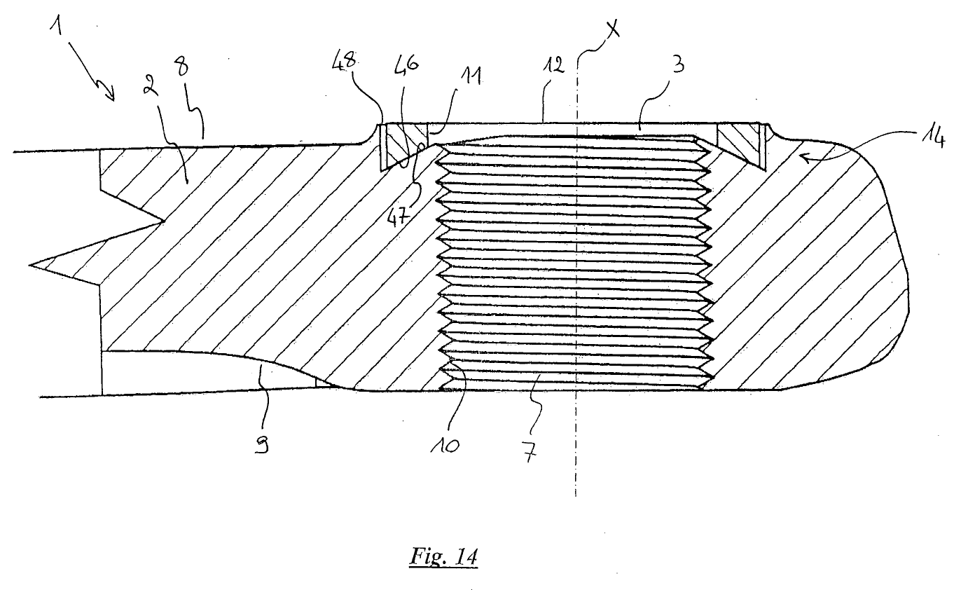

As a further alternative, in the embodiment of FIG. 14 the contact surface 46 of the washer 3 is conical diverging towards the crank arm 2, and the contact surface 47 of the crank arm 2 is conical converging towards the washer 3, similar to the embodiment of FIG. 10, but the seat for receiving the washer 3 is a recessed seat 14 in the crank arm 2.

In that case, the conical contact surface 47 of the crank arm 2 protrudes within the seat 14 and wedges into the flaring of the contact surface 46 of the washer 3. When the protrusion of the crank arm 2 expands because of the tensile stress of the axle 100 inserted in the hole 7, it places the washer 3 under tensile stress adding in this case a mechanical effect to the effect of friction.

It should be noted that between the seat 14 of the crank arm 2 and the washer 3 there is an optional annular clearance 48.

In view of the fact that the force that the cyclist exerts on the pedal changes in strength during the pedaling cycle as a function of the angular position of the crank arm assembly 1, alternatively or additionally to providing a mechanical constraint, it is possible to modify the mutual contact surfaces of the crank arm 2 and the washer 3 so as to increase the friction A during the portion of the pedaling cycle when the greater force is exerted with respect to the portion of the pedaling cycle when the smallest force is exerted. This can be obtained by providing for the extent of the mutual contact surfaces of the crank arm and the washer at different angular positions around the axis X to be different.

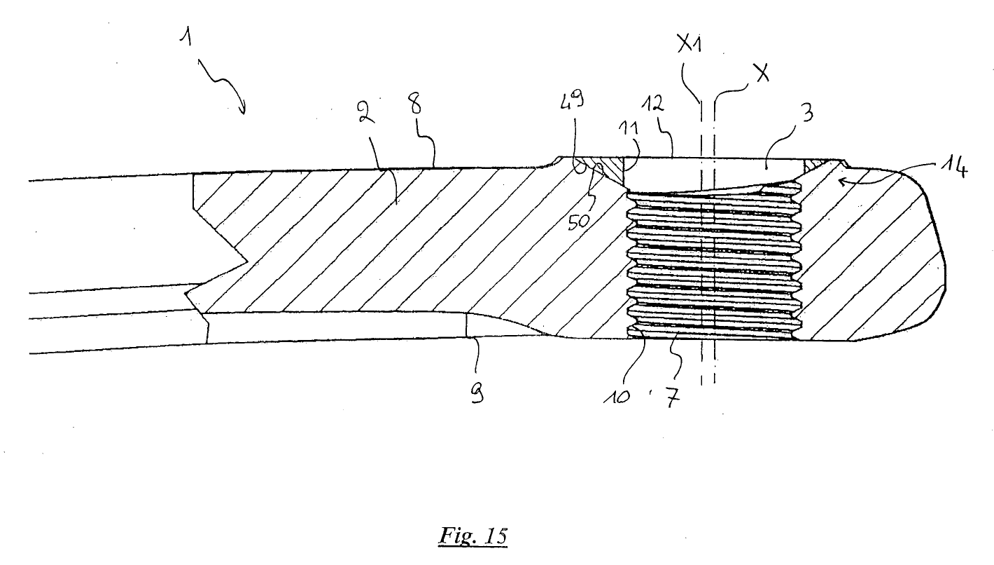

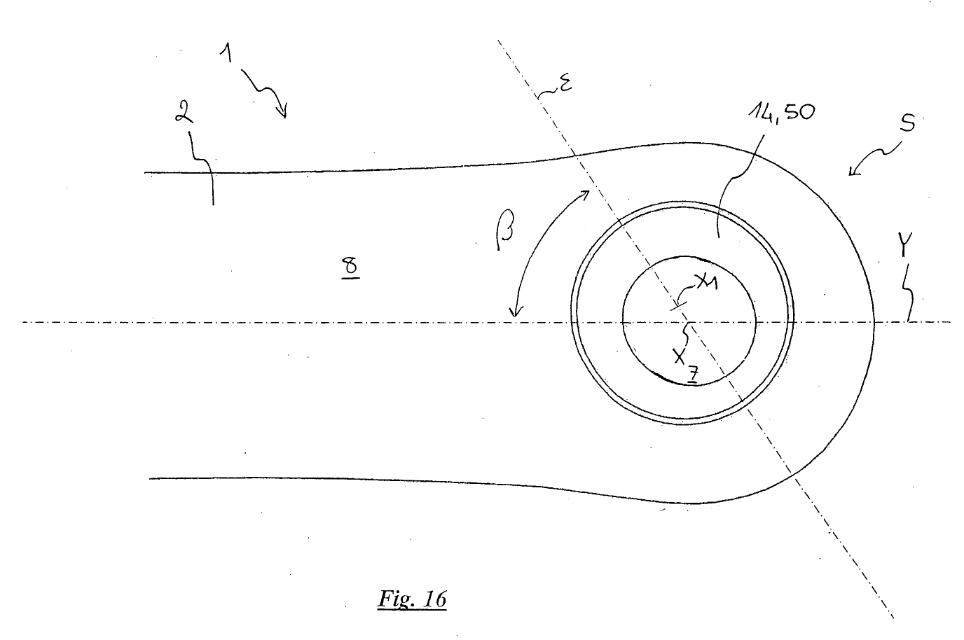

Thus, in the embodiment shown in FIGS. 15 and 16, the contact surface 49 of the washer 3 and the contact surface 50 of the crank arm 2 are conical, but eccentric with respect to the hole 7 of the crank arm 2 and to the central hole 11 of the washer 2. The axis X1 of the cone that defines the mutual contact surfaces 49, 50 is preferably parallel to the axis X, and preferably defines, with the axis X, a plane ε sloping with respect to the longitudinal center line Y of the crank arm 2 by an angle β comprised between 30° and 70°.

It will be understood that the other mutual contact surfaces described above could also be made eccentric.

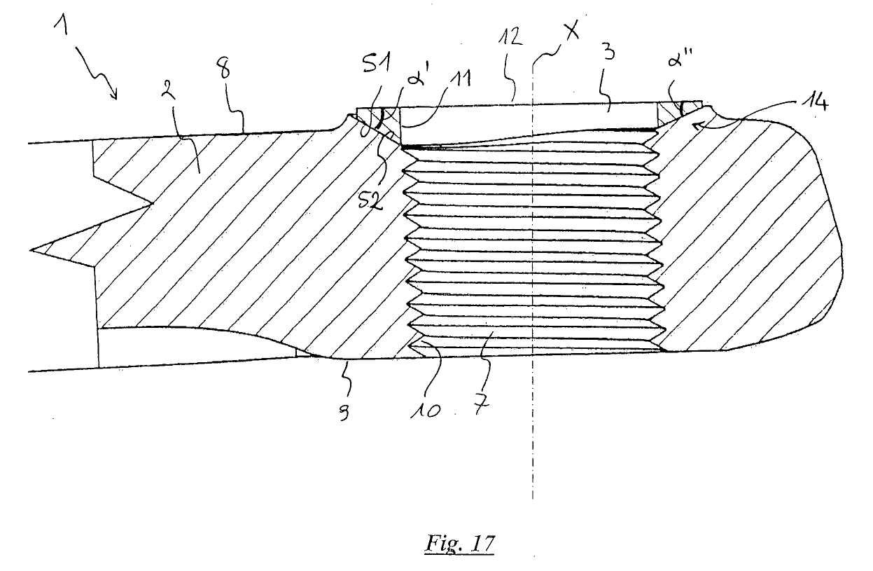

As a further example, in the embodiment shown in FIG. 17, the contact surface 51 of the washer 3 and the contact surface 52 of the crank arm 2 have variable slopes as a function of the angular position around the axis X. In FIG. 17 the two slopes α′ and α″ are identified at the two angular positions defined by the longitudinal axis Y of the crank arm 2.

The slope can vary, for example, between 5° and 45°, in a gradual manner all around the axis X. In an embodiment that is particularly simple to carry out, the contact surfaces 51, 52 with gradually variable slope are conical surfaces with sloping axes with respect to the axis X of the hole 7.

The slope of the surfaces 51, 52 can, however, vary also in sectors, or there can be a first sector that extends for a first predetermined arc of circumference with a minimum slope, a second sector that extends for a second predetermined arc of circumference with a maximum slope, and two joining sectors where the slope varies gradually, preferably linearly, between the minimum slope and the maximum slope.

Mutual contact surfaces of the crank arm 2 and the washer 3 that are not rotational surfaces, i.e., that do not have circular symmetry like, for example, frustum of pyramid-shaped surfaces or more generally faceted surfaces, can be used. In this case, similar to the case of the embodiment of FIGS. 15 and 16 and of FIG. 17, the mutual rotation between the crank arm 2 and the washer 3 about the axis X is also prevented.

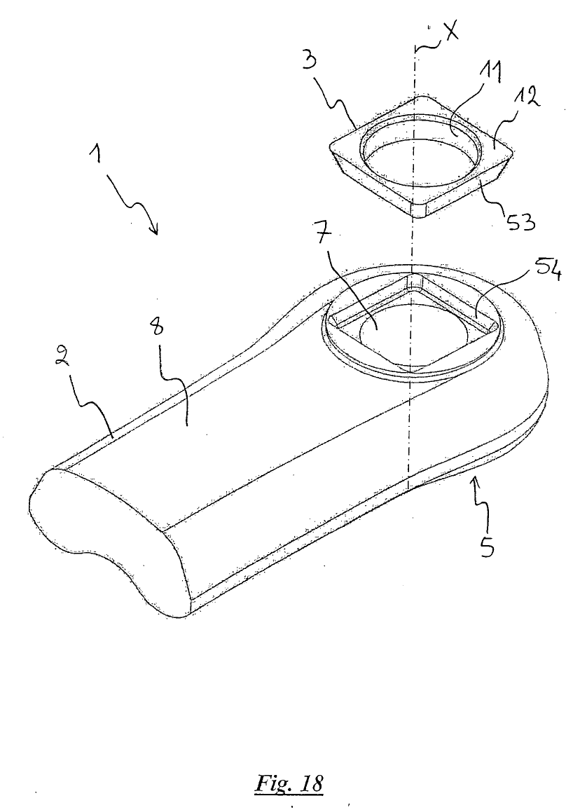

FIG. 18 shows a crank arm assembly 1 wherein the mutual contact surfaces 53, 54 of the washer 3 and of the crank arm 2, respectively, are frustum of square pyramid-shaped surfaces, with smoothed edges. The base of the pyramid can have any number of sides; moreover, also in the case of multi-facetted or pyramid-shaped mutual contact surfaces, the axis can be sloping and/or eccentric with respect to the axis X.

Moreover, in the various embodiments described above, the substantially flat surface 12 of the washer 3 and/or the abutment surface 103 of the axle 100 could be replaced by a knurled, grooved, or otherwise textured surface. Furthermore, the hole 11 of the washer 3 could be conical or more generally could have a divergent or convergent progression corresponding to the overall progression of its surface for contacting with the crank arm 2, so as to obtain a thinner washer 3, of advantageously less weight.

Those skilled in the art will also understand that what has been described and illustrated applies to the hole 6 for coupling with the axle of the bottom bracket assembly, as an alternative or in addition to the hole 7 for coupling with the pedal.

One or other of the hole 6 for coupling with the bottom bracket assembly axle and the hole 7 for coupling with the pedal can also be replaced by an axle made integrally with the crank arm, a hole being instead provided in the pedal or in the bottom bracket assembly, respectively.

What is claimed is:

1. A bicycle crank arm assembly comprising a crank arm having a first end for coupling with a bottom bracket assembly and a second end for coupling with a pedal, at least one of said first end and said second end comprising a hole extending from a side of the crank arm for coupling with an axle of the pedal or of the bottom bracket assembly, respectively, further comprising a reinforcing element, extending around the hole in the proximity of said side of the crank arm, having a portion configured for receiving an abutment portion of said axle resting upon it, and wherein the crank arm and the reinforcing element contact along a respective surface not entirely contained within a plane perpendicular to an axis through the hole.

2. Crank arm assembly according to claim 1, wherein the mutual contact surfaces have an overall sloping progression with respect to the axis.

3. Crank arm assembly according to claim 1, wherein in the direction of the axis, the extent of said mutual contact surfaces is shorter than the extent of the hole.

4. Crank arm assembly according to claim 3, wherein in the direction of the axis, the extent of said mutual contact surfaces is shorter than half the extent of the hole.

5. Crank arm assembly according to claim 4, wherein in the direction of the axis, the extent of said mutual contact surfaces is shorter than one fifth of the extent of the hole.

6. Crank arm assembly according to claim 1, wherein in the direction of the axis, the extent of said mutual contact surfaces comprises between one pitch of an internal threading of the hole and twice the pitch.

7. Crank arm assembly according to claim 1, wherein the reinforcing element has a greater modulus of elasticity than that of the crank arm.

8. Crank arm assembly according to claim 1, wherein the reinforcing element is made from a material selected from the group comprised of steel, titanium alloy, and aluminum alloy.

9. Crank arm assembly according to claim 1, wherein the mutual contact surfaces are conical surfaces.

10. Crank arm assembly according to claim 9, wherein a generating line of the conical mutual contact surfaces is sloping with respect to a plane perpendicular to the axis by an angle comprised between 5° and 45°.

11. Crank arm assembly according to claim 1, wherein the mutual contact surfaces are rotational surfaces having a curvilinear generating line with at least one inflexion point.

12. Crank arm assembly according to claim 11, wherein the curvilinear generating line has at least two inflexion points.

13. Crank arm assembly according to claim 1, wherein the mutual contact surfaces are rotational surfaces having a stepped generating line.

14. Crank arm assembly according to claim 1, wherein the mutual contact surfaces are rotational surfaces having a generating line shaped as an arc of circumference.

15. Crank arm assembly according to claim 1, wherein the mutual contact surfaces are multi-faceted surfaces.

16. Crank arm assembly according to claim 15, wherein the mutual contact surfaces are frustum of pyramid-shaped surfaces.

17. Crank arm assembly according to claim 1, wherein the contact surface of the reinforcing element overall converges towards the crank arm, and the contact surface of the crank arm overall diverges towards the reinforcing element.

18. Crank arm assembly according to claim 1, wherein the contact surface of the reinforcing element overall diverges towards the crank arm, and the contact surface of the crank arm overall converges towards the reinforcing element.

19. Crank arm assembly according to claim 1, wherein the crank arm comprises a recessed seat for housing the reinforcing element.

20. Crank arm assembly according to claim 1, wherein the crank arm comprises a protruding seat for housing the reinforcing element.

21. Crank arm assembly according to claim 1, further comprising a mechanical constraint between the crank arm and the reinforcing element.

22. Crank arm assembly according claim 21, wherein said mechanical constraint comprises a caulking.

23. Crank arm assembly according to claim 22, wherein the crank arm comprises a recessed seat for housing the reinforcing element, and said mechanical constraint comprises a caulking of the crank arm or of the reinforcing element around the seat for the reinforcing element.

4. Crank arm assembly according to claim 22, wherein the crank arm comprises a protruding seat for housing the reinforcing element, and said mechanical constraint comprises a caulking of the crank arm or of the reinforcing element around said seat.

25. Crank arm assembly according to claim 21, wherein the crank arm is made from a composite material and said mechanical constraint is accomplished by co-molding of the reinforcing element in said crank arm.

26. Crank arm assembly according to claim 1, wherein the mutual contact surfaces between the crank arm and the reinforcing element have a different extent at different angular positions about the axis.

27. Crank arm assembly according to claim 26, wherein the mutual contact surfaces between the crank arm and the reinforcing element are eccentric surfaces with respect to the hole.

28. Crank arm assembly according to claim 27, wherein the axis of the mutual contact surfaces is parallel to the axis, and defines, with the axis, a plane sloping with respect to a longitudinal center line of the crank arm by an angle comprised between 30° and 70°.

29. Crank arm assembly according to claim 26, wherein the mutual contact surfaces of the crank arm and the reinforcing element have a different slope at different angular positions about the axis.

30. A bicycle crank arm having a first end for coupling with an axle of a bottom bracket assembly and a second end for coupling with a pedal, at least one of said first end and said second end comprising a hole extending from a side of the crank arm for coupling with an axle of the pedal or respectively of the bottom bracket assembly, comprising, in the proximity of said side, a surface configured for contacting a reinforcing element not entirely contained within a plane perpendicular to an axis of the hole.

31. Crank arm according to claim 30, wherein the contact surface defines a recessed seat in the crank arm.

32. Crank arm according to claim 30, wherein the contact surface defines a protrusion in the crank arm.

33. Crank arm according to claim 30, wherein the contact surface is a rotational surface.

34. Crank arm according to claim 33, wherein the rotational surface is a conical surface.

35. Crank arm according to claim 33, wherein the rotational surface has a curvilinear generating line with at least one inflexion point.

36. Crank arm according to claim 33, wherein the rotational surface has a stepped generating line.

37. Crank arm according to claim 33, wherein the rotational surface has a generating line shaped as an arc of circumference.

38. Crank arm according to claim 30, wherein the contact surface is multi-faceted.

39. Crank arm according to claim 38, wherein the contact surface is frustum of pyramid-shaped.

40. Crank arm according to claim 30, wherein the contact surface has a different extent at different angular positions about the axis.

41. Crank arm according to claim 28, wherein the contact surface is an eccentric surface with respect to the hole.

42. Crank arm according to claim 40, wherein the contact surface has a different slope at different angular positions about the axis.

43. A reinforcing element for a bicycle crank arm comprising a hole that allows passage of an axle of a pedal or of a bottom bracket assembly, respectively, a portion configured for receiving an abutment portion of said axle resting upon it, and a surface configured for contacting the crank arm not entirely contained within a plane perpendicular to an axis of the hole.

44. Reinforcing element according to claim 43, wherein the abutment portion comprises an abutment surface essentially opposite the contact surface.

45. Reinforcing element according to claim 43, wherein the contact surface is conical.

46. Reinforcing element according to claim 43, wherein the contact surface is a rotational surface having a curvilinear generating line with at least one inflexion point.

47. Reinforcing element according to claim 43, wherein the contact surface is a rotational surface having a generating line shaped as an arc of circumference.

48. Reinforcing element according to claim 43, wherein the contact surface is a rotational surface having a stepped generating line.

49. Reinforcing element according to claim 43, wherein the contact surface is multi-faceted.

50. Reinforcing element according to claim 49, wherein the contact surface is a frustum of pyramid-shaped surface.

51. Reinforcing element according to claim 43, wherein the contact surface is eccentric with respect to the hole.

52. A bicycle crank arm assembly comprising:
a crank arm comprising
a first end for coupling with a bottom bracket assembly, and
a second end for coupling with a pedal, at least one of said first end and said second end comprising a hole extending from a side of said crank arm for coupling with an axle of the pedal or of the bottom bracket assembly, respectively; and
a reinforcing element extending around said hole in the proximity of said side of said crank arm, said reinforcing element comprising a portion configured for receiving an abutment portion of said axle resting upon it,
wherein said crank arm and said reinforcing element contact along essentially conical mutual contact surfaces.

53. The bicycle crank arm assembly according to claim 52, wherein the crank arm comprises a recessed seat for housing the reinforcing element.

54. The bicycle crank arm assembly according to claim 52, wherein said hole comprises internal threading.

55. The bicycle crank arm assembly according to claim 52, wherein said reinforcing element has a greater modulus of elasticity than that of said crank arm.

56. The bicycle crank arm assembly according to claim 52, wherein a generating line of said conical mutual contact surfaces is sloping with respect to a plane perpendicular to an axis of said hole by an angle comprised between 5° and 45°.

57. The bicycle crank arm assembly according to claim 52, wherein in the direction of an axis of said hole, the extent of said mutual contact surfaces amounts to between one pitch of an internal threading of said hole and twice the pitch.

58. The bicycle crank arm assembly according to claim 52, wherein said reinforcing element comprises an annular shape.

59. The bicycle crank arm assembly according to claim 52, wherein the configuration of said reinforcing element is continuous around an axis of said hole.

60. A bicycle crank arm assembly comprising:
a crank arm comprising
a first end for coupling with a bottom bracket assembly, and
a second end for coupling with a pedal, at least one of said first end and said second end defining a traverse hole for coupling with an axle of the pedal or of the bottom bracket assembly, respectively; and
a reinforcing element extending around said hole, said reinforcing element comprising a portion configured for receiving an abutment portion of said axle resting upon it,
wherein said crank arm and said reinforcing element contact along a respective substantially conical surface.

61. A bicycle crank arm assembly comprising:
a crank arm comprising
a first end for coupling with a bottom bracket assembly axle, and
a second end for coupling with a pedal axle, at least one of said first end and said second end comprising a hole for coupling with an axle of the pedal or of the bottom bracket assembly, respectively; and
a reinforcing element extending around said hole, and confined in a zone close to an edge of the hole.

62. The bicycle crank arm assembly according to claim 61, wherein the reinforcing element embraces a free area with a cross section greater than a cross section of the hole close to the reinforced element.

63. The bicycle crank arm assembly according to claim 62, wherein the hole is defined by an internally threaded surface for coupling with a threading of the axle, while the reinforcing element has a smooth surface facing the embraced free area.

64. A bicycle crank arm assembly comprising:
a crank arm comprising
a first end for coupling with a bottom bracket assembly axle, and
a second end for coupling with a pedal axle, at least one of said first end and said second end comprising a hole for coupling with an axle of the pedal or of the bottom bracket assembly, respectively; and
a reinforcing element extending around said hole, wherein the reinforcing element embraces a free area with a cross section greater than a cross section of the hole close to the reinforced element.

65. A bicycle crank arm assembly comprising:
a crank arm comprising
a first end for coupling with a bottom bracket assembly, and
a second end for coupling with a pedal, at least one of said first end and said second end defining an hole for coupling with an axle of the pedal or of the bottom bracket assembly, respectively; and
a reinforcing element, extending around the hole, and having a portion configured for receiving an abutment portion of said axle resting upon it, and
wherein the crank arm and the reinforcing element contact along a respective surface not entirely contained within a plane perpendicular to an axis through the hole, and
wherein the contact surface of the reinforcing element overall converges towards the crank arm, and the contact surface of the crank arm overall diverges towards the reinforcing element.
